(19) United States
(12) Patent Application Publication
(10) Pub. No.: US 2005/0108146 A1
(43) Pub. Date: May 19, 2005

(54) System and method for establishing an exchange traded fund

(76) Inventor: H. Bruce Bond, Wheaton, IL (US)

Correspondence Address: MAYER, BROWN, ROWE & MAW LLP, 190 SOUTH LASALLE ST, CHICAGO, IL, 60603-3441, US

(21) Appl. No.: 10/972,995

(22) Filed: Oct. 25, 2004

Related U.S. Application Data
(60) Provisional application No. 60/519,698, filed on Nov. 13, 2003.

(51) Int. Cl. G06F 17/60

(52) U.S. Cl. 705/37

(57) ABSTRACT

A system for the sale of shares of an exchange traded fund comprising: establishing a subscription period wherein assets are accumulated for purchase underlying securities of the exchange traded fund and for payment of a selling commission to one or more selling firms; following the subscription period, paying the selling commission to the one or more selling firms and using the remaining assets to purchase underlying securities; dividing the purchase of the underlying securities into shares of the fund; and commencing listing of shares of the fund.

This application claims priority from U.S. Provisional Patent Application 60/519,698, filed Nov. 13, 2003, incorporated herein by reference.

### BACKGROUND OF THE INVENTION

1. Field of the Invention

The present invention relates to a system and method for establishing an exchange traded fund. Particularly, the present invention is directed to a system and method for establishing an exchange traded fund wherein a selling concession is distributed to one or more selling agents prior to listing shares of the fund for trading.

2. Description of Related Art

Exchange traded funds (“ETFs”) have arisen to allow investors to invent in a class of funds that, broadly contemplated, track the performance of one or more well known indexes. These funds typically purchase the underlying securities which form the make up of the preferred index and distribute shares of the fund to investors at the net asset value (“NAV”) of the underlying securities. These types of funds are useful in that they provide a good diversification of risk and allow investors to invest in particular market sectors through the investment of funds in underlying securities that have been preferentially selected to represent the performance of the particular sector or market to which the index, and therefore the fund, relates.

However, because ETFs are contemplated to always trade at or near the NAV, the trading structure and inherent nature of ETFs does not lend itself to the incorporation of an underwriting fee of sales charge. That is, incorporation of a sales charge into the price of the shares of the fund would complicate the creation and redemption process. For typical open-ended ETSs, a trust purchases underlying securities, and investors actually purchase shares of the trust. Shares of the trust are created in blocks of, for example, 1000 shares, called creation units, which can be redeemed at any time by an investor. Thus, an investor who has accumulated enough shares (i.e., at least on creation unit) may exchange his shares of the trust for the shares of the underlying securities that the shares of the trust represent. Accordingly, the shares of the trust always trade at or near the NAV because the shares of the trust can be exchanged for the underlying securities at their NAV. Incorporation of a selling concession or fee rolled into the price of the fund shares would upset the delicate balance between the price of the shares of the fund and the NAV of the underlying securities, upsetting the creation and redemption process.

Therefore, it is difficult for ETF sponsors to effectively engage and compensate financial institutions and financial professionals for distributing and selling their products. The consequence is that ETFs have not been distributed through lucrative initial public offering (“IPO”) distribution channels. Broker-Dealer product support, service and coverage is also substantially diminished in the industry because the products are not profitable for financial institutions when compared to other financial instruments and do not fit within the normal operations and economic framework of existing financial products. These disadvantages of the current ETF market have caused weakness in the ETF industry and an unhealthy concentration of assets within a few large products. This massive and abnormal asset concentration along with extremely high market penetration costs are serious concerns for ETF providers who are finding it almost impossible to gain scale, visibility and shelf space in such a capital intensive and competitive arena. ETF managers understand this to be a critical problem, yet no one has been able to devise a solution to overcome concerns that any type of sales charge will disturb and compromise the delicate arbitrage and trading structure of the ETF, thereby destroying the inherent value of the product.

Development of methods for establishing an ETF which take advantage of a selling syndicate have historically failed for a number of reasons. First, the United States Securities and Exchange Commission (the “SEC”) has not historically allowed ETFs to conduct an IPO-like offering wherein a selling concession is paid out of assets accumulated from the initial round of investors. Under SEC rules, to participate in an IPO, the first round of investors needs to receive some benefit, i.e., buyers on day one should receive some benefit over buyers who purchase the same product on an open market. Prior to the instant invention, such a system had not been devised. Second, as described previously, the inclusion of a selling charge into the price of the ETF upsets the arbitrage between the price of shares of the ETF and the NAV. Third, attempts to provide for an initial selling concession have historically been limited to closed-end funds. In those cases, the initial buyer may pay a higher price, but the benefit received is that because the fund shares cannot be redeemed, the price of the fund shares may end up trading at a premium relative to the NAV, providing a benefit to the intitial purchaser whose purchase was made at an opening NAV (albeit plus a sales charge). However, the same considerations have historically not applied to ETFs because, as open ended funds, they do not trade at a premium. Instead, they are designed to trade at or near their NAV. This feature means that the SEC cannot use a future premium trading price as a justification for allowing an initial selling concession.

A system and method that addresses the above concerns is presented herein.

### SUMMARY OF THE INVENTION

The purpose and advantages of the present invention will be set forth in and apparent from the description that follows, as well as will be learned by practice of the invention. Additional advantages of the invention will be realized and attained by the methods and systems particularly pointed out in the written description and claims hereof.

To overcome the disadvantages of the prior art, a system and method of establishing an exchange traded fund has been created which divides the process into two periods: a subscription period and a listing period. During the subscription period, assets are accumulated from investors, through a selling syndicate or distribution network, which assets include a selling concession to be paid to members of the distribution network of the fund. The selling concession, ideally set as a percentage of the investment, is set aside by the participating firms in the distribution network prior to the purchase of the underlying securities for the fund. Thereafter, notwithstanding any applicable short penalty-bid period, the securities are purchased and shares are issued based on the net asset value of the fund. The fund can then be listed and traded at or near the net asset value without affecting the pure nature of the instrument.

The advantage of the present system is that a selling concession is paid to the distribution network without having to incorporate costs into the price of shares of the fund, thereby allowing the fund to trade based solely on what the market views as the value of the shares, typically at or near its NAV. It is expected that the SEC will approve such a structure under so long as the selling concession is less than the commission the initial investors would expect to pay to their broker-dealer and the spread of the fund as traded on the exchange. Preferably, the selling concession is approximately two percent, although the selling syndicate can establish a break point schedule of applicable selling concessions to ensure that investors do not pay more than what they would pay on the secondary market.

Another advantage of the present system is that a distribution network is established with an inherent incentive to sell shares of the fund. This incentive arises in part from the fact that the selling syndicate keeps the full selling concession rather than having to pay commissions to the exchange that it would have to pay if it were purchasing shares of the fund after the funds began trading. Thus, more widespread investment in the fund can be achieved.

In addition, the use of a selling syndicate leverages the marketing capacity of members of the selling syndicate, preferably large investment banks, to increase demand for the fund and thereby allow the fund to attract more money and trade more efficiently.

To achieve these and other advantages and in accordance with the purpose of the invention, as embodied and broadly described, an embodiment of the invention includes a system for the sale of shares of an exchange traded fund comprising: establishing a subscription period wherein assets are accumulated for purchase underlying securities of the exchange traded fund and for payment of a selling commission to one or more selling firms; following the subscription period, paying the selling commission to the one or more selling firms and using the remaining assets to purchase underlying securities; dividing the purchase of the underlying securities into shares of the fund; and commencing listing of shares of the fund.

Yet another embodiment of the invention is, in brief, a method for raising assets for an exchange traded fund comprising: establishing a subscription period; during the subscription period: establishing an offering price for shares of the exchange traded fund based on an expected opening net asset value for the fund, wherein the offering price comprises the expected opening net asset value plus a selling concession; accumulating assets for the exchange traded fund by selling interests in the exchange traded fund based on the expected opening net asset value plus the selling concession; distributing the selling concession to one or more selling firms; and purchasing underlying securities for the exchange traded fund; establishing a listing period at the conclusion of the subscription period; during the listing period: dividing the underlying securities into shares of the exchange traded fund according to the expected opening net asset value; and commencing trading of the shares of the fund at an opening net asset value.

It is to be understood that both the foregoing general description and the following detailed description are exemplary and are intended to provide further explanation of the invention claimed.

### DETAILED DESCRIPTION OF THE PREFERRED EMBODIMENTS

Reference will now be made in detail to the present preferred embodiments of the invention. The method and corresponding steps of the invention will be described in conjunction with the detailed description of the system.

The methods and systems presented herein may be used for enhancing the availability and incentives for establishing an exchange traded fund. The present invention is particularly suited for establishing an exchange traded fund wherein a selling concession is charged during an initial subscription period, thereby allowing a selling syndicate to introduce, market and profit from sales of the fund, and competitively compensating broker-dealers, without affecting the value of the shares during trading.

The first step in the invention is to establish a subscription period. A subscription period according to embodiments of the invention is the period in which assets are accumulated for the following purposes: purchase the underlying securities that will make up the fund's holdings, and to accumulate a selling concession that will be retained by the selling network. The subscription period precedes the listing and trading of shares of the ETF.

It should be understood that the present invention applies not only to ETFs in the traditional sense, but also non-traditional ETFs. Such non-traditional ETFs are fundamentally similar to traditional ETFs in that the underlying securities match the underlying securities in the index which the ETF is meant to track, but the weighting of the holdings of those securities may differ from the weighting of the securities in the index on which the ETF is based. An example of such non-traditional ETF is an Intellidex™ fund, presently traded on the American Stock Exchange.

According to embodiments of the invention, the assets accumulated during the subscription period are accumulated by the selling syndicate. The selling syndicate transfers a portion of those assets to a Trust to purchase underlying securities to match the index which the ETF is designed to track. As explained above, the Trust may decide, in the discretion of the Trust, how much of each underlying security to purchase so as to maximize the performance of the ETF. The remainder of the assets is retained by and distributed within the selling syndicate as a selling commission. No further selling commissions are rolled into the price of the fund (although individual broker-dealers may continue to charge commissions for trades in the ordinary course of their dealings with investors).

Once all of the assets for purchase of the underlying securities have been accumulated, the Trust will determine how to issue shares of the fund by calculating an expected opening NAV. This expected opening NAV will be the total dollar value of the assets for the purchase of the underlying securities, divided by the total number of shares to be issued. In one embodiment, the expected opening NAV will be $10.00, although any expected opening NAV may be used based on the following factors: marketability, desired liquidity, or other factors. Thus, if the selling commission is two percent, as in a preferred embodiment, the selling syndicate will have to raise $10.20 for each share of the ETF that the Trust will issue to the applicable investor. In a preferred embodiment, the selling syndicate will issue shares in a minimum investment of 100 shares, meaning each investor will have had to have invested at least $1,020.00.

According to a preferred embodiment, the subscription period will last thirty days, although a longer or shorter time period may be appropriate. Just prior to the close of the subscription period, the ETF is seeded with the holdings, i.e., the underlying securities. In the preferred embodiment, the period for purchasing the holdings would be five to fifteen days. Preferably, one day prior to the last day of the subscription period, the ETF will be “ghost listed” on the applicable exchange to allow conversion of the initial shares to actual shares available for trading. At this time, the opening NAV for the fund may deviate from the expected opening NAV based on a fluctuation of the value of the underlying securities over this five day period.

It will be apparent to those skilled in the art that various modifications and variations can be made in the method and system of the present invention without departing from the spirit or scope of the invention. Thus, it is intended that the present invention include modifications and variations that are within the scope of the appended claims and their equivalents.

1. A system for the sale of shares of an exchange traded fund comprising:
establishing a subscription period wherein assets are accumulated for purchase underlying securities of the exchange traded fund and for payment of a selling concession to one or more selling firms;
prior to the conclusion of the subscription period, paying the selling concession to the one or more selling firms and using the remaining assets to purchase underlying securities;
dividing the purchase of the underlying securities into shares of the fund; and
commencing trading of shares of the fund.

2. The system of claim 1 wherein the selling commission is approximately two percent of the assets.

3. The system of claim 1 further comprising establishing an expected opening net asset value for the fund, and accumulating assets during the subscription period based on the expected opening net asset value plus a predetermined fee.

4. The system of claim 1 further comprising listing the fund on an exchange prior to trading.

5. The system of claim 1 further comprising converting the assets of the fund into creation units.

6. The system of claim 1 wherein the selling concession is less than the commission charged on sales of the shares of the fund.

7. A method for raising assets for an exchange traded fund comprising:
establishing a subscription period;
during the subscription period:
establishing an offering price for shares of the exchange traded fund based on an expected opening net asset value for the fund, wherein the offering price comprises the expected opening net asset value plus a selling concession;
accumulating assets for the exchange traded fund by selling interests in the exchange traded fund based on the expected opening net asset value plus the selling concession;
distributing the selling concession to one or more selling firms; and
purchasing underlying securities for the exchange traded fund;
establishing a listing period at the conclusion of the subscription period;
during the listing period:
dividing the underlying securities into shares of the exchange traded fund according to the expected opening net asset value; and
commencing trading of the shares of the fund at an opening net asset value.

8. The method of claim 7 wherein the selling concession is approximately two percent of the expected opening net asset value.

9. The method of claim 7 further comprising listing the fund on an exchange prior to the end of the subscription period.

10. The method of claim 7 further comprising converting the assets of the fund into creation units.

11. A system for establishing an exchange trade fund comprising:
establishing a subscription period during which a selling syndicate of one or more selling firms accumulates assets from investors, said assets including a selling concession;
providing the assets less the selling concession to a trust for the purchase of underlying securities for the exchange trade fund and distributing the selling concession to the one or more selling firms;
receiving shares of the exchange traded fund that may be redeemed for the underlying securities; and
distributing the shares of the exchange traded fund to the investors.

12. The system of claim 11 wherein the selling concession is approximately two percent of the accumulated assets.

13. The system of claim 11 wherein the selling concession per share of the exchange traded fund is less than the commission charged for trading of a share of the exchange traded fund.

14. A method for establishing an exchange traded fund comprising:
receiving assets accumulated by a selling syndicate comprising one or more selling firms for the purchase of underlying securities of the exchange traded fund, said assets comprising money accumulated by the selling syndicate less a selling commission retained by the selling syndicate;
establishing a trust for the purchase and management of the underlying securities;
purchasing the underlying securities;
issuing shares of the trust to the selling syndicate representing the underlying securities; and
allowing trading of the shares.

15. The method of claim 14 further comprising permitting the redemption of shares of the trust for the underlying securities.

16. The method of claim 14 wherein the selling concession is approximately two percent of the money accumulated.

17. The method of claim 14 wherein the selling concession is less than the commission charged for trading of a share.
